(19) United States
(12) Patent Application Publication
(10) Pub. No.: US 2014/0217006 A1
(43) Pub. Date: Aug. 7, 2014

(54) Fuel supply system for a vehicle with internal combustion engine

(71) Applicant: MANN+HUMMEL GMBH, Ludwigsburg (DE)

(72) Inventors: Lars Spelter, Korntal-Muenchingen (DE); Gernot Boiger, Buelach (DE)

(73) Assignee: MANN+HUMMEL GMBH, Ludwigsburg (DE)

(21) Appl. No.: 14/085,375

(22) Filed: Nov. 20, 2013

(30) Foreign Application Priority Data
Nov. 22, 2012 (DE) 10 2012 022 762.0

(51) Int. Cl. B01D 17/04

(52) U.S. Cl. CPC B01D 17/045
USPC 210/295; 210/513

(57) ABSTRACT

A fuel supply system for a vehicle with internal combustion engine features a fuel tank and a water separator integrated in the fuel tank.

### CROSS REFERENCE TO RELATED APPLICATION

This application claims the benefit under 35 USC 119 of foreign application DE 10 2012 022 762.0 filed in Germany on Nov. 22, 2012, and which is hereby incorporated by reference in its entirety.

### TECHNICAL FIELD

The invention relates to a fuel supply system for a vehicle with internal combustion engine.

### BACKGROUND OF THE INVENTION

US 2002/0005177 A1 describes a fuel supply system for an internal combustion engine that features a fuel tank, a fuel pump as well as a hydrophobic filter element allocated to the pump. The hydrophobic filter element is located immediately upstream of the inflow to the fuel pump and is, therefore, capable of separating water droplets from the fuel to be supplied before they enter the fuel pump.

### SUMMARY OF THE INVENTION

An object of the invention is to disclose and provide a space-saving fuel supply system including a water separation with simple constructive measures for a vehicle having an internal combustion engine.

The fuel supply system according to the invention can be used in vehicles having an internal combustion engine and comprises a fuel tank from which the fuel is supplied into the cylinders of the internal combustion engine during operation. The fuel supply system is equipped with a water separation that enables the water content in the fuel to be separated before being supplied into the cylinders of the internal combustion engine.

In the embodiment according to the invention, a water separator is integrated into the fuel tank which is disposed within the tank in the flow path of the fuel between a fuel inlet and a fuel outlet In this way, a particularly compact design is achieved, for no additional mounting space is needed for the water separator outside of the fuel tank. Another advantage is that the water separator is disposed upstream of the fuel supply pump and therefore in the pressureless area of the fuel supply system. Thus, the water content in the fuel is already separated before entering the fuel pump. A disintegration of the water droplets in the water pump is avoided due to shear forces which improves the water separation efficiency, for the larger water droplets upstream of the fuel supply pump can be easier separated in the water separator.

The water separator is located in the flow path between the fuel inlet via which the fuel is supplied into the tank, and the fuel outlet via which the fuel is discharged from the tank. Therefore, the water separator is flowed through by the fuel in the tank, enabling it to unfold its water-separating effect. Advantageously, the water separator has a structure which has, as a consequence, only a minimal pressure loss of the through-flowing fuel approaching zero, for example an open fabric. The water separator is preferably designed as coalescer element that supports an agglomeration and combination of smaller water droplets to form larger drops which are then discharged under the effect of their apparent weight.

A water reservoir, which is placed underneath the water separator, is expediently allocated to the water separator in the fuel tank. In the water reservoir is collected the separated water, which is discharged from the water reservoir either continuously or discontinuously.

According to a further appropriate embodiment, the fuel inlet is located in the upper side of the fuel tank and the water separator directly underneath the upper lying fuel inlet. In this way, the apparent weight of the fuel supplied into the fuel tank can be used for the through-flowing of the water separator. Furthermore, this ensures that the totality of the fuel supplied into the fuel tank flows through the water separator.

According to a further advantageous embodiment, the fuel inlet and the fuel outlet are disposed on opposing sides of the fuel tank. The water separator is located adjacent to the fuel inlet and therefore on the side opposing the fuel outlet.

According to still another embodiment, two different fuel inlets are realized in the fuel tank, the two different fuel inlets are disposed advantageously adjacent to each other, wherein the water separator faces both fuel inlets. In particular, both fuel inlets are realized in the upper part of the fuel tank, wherein the water separator is placed directly underneath of both fuel inlets. The first fuel inlet serves to supply fuel, the second fuel inlet enables a return flow from the fuel filter disposed outside of the fuel tank or from the high-pressure side of a fuel supply pump.

According to still another appropriate embodiment, a hydrophobic barrier layer is disposed between the water separator and the fuel outlet in the fuel tank. The object of the hydrophobic barrier layer is to prevent water drops collected in the water separator from being conveyed towards the fuel outlet. The hydrophobic barrier layer is thus an additional security level against undesired evacuation of the water droplets towards the internal combustion engine. The hydrophobic barrier layer is designed as separate component, independent of the water separator and consists either of a hydrophobic material or of a base support coated with a hydrophobic material. According to an advantageous embodiment, the hydrophobic barrier layer features a fine-meshed grid made of the hydrophobic material or with a hydrophobic coating.

The hydrophobic barrier layer can have a flat design and is expediently extending diagonally. In this connection, the deepest point of the hydrophobic barrier layer is facing a water reservoir so that water drops, which are separated at the hydrophobic barrier layer or are agglomerated there, can flow towards the water reservoir. The water reservoir is advantageously identical with the water reservoir which is located below the water separator.

According to a further appropriate embodiment, the fuel supply pump is disposed downstream of the water separator. In this connection, the fuel supply pump can either be integrated into the fuel tank, offering the advantage of a compact space-saving design, or placed downstream of the fuel tank. If arranged within the fuel tank, the fuel supply pump is expediently located directly at the fuel outlet.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 is a schematic view of a fuel supply system for a vehicle with internal combustion engine; and

FIG. 2 is another schematic view of a fuel supply system for a vehicle with internal combustion engine.

Identical components in the figures have the same reference numerals Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

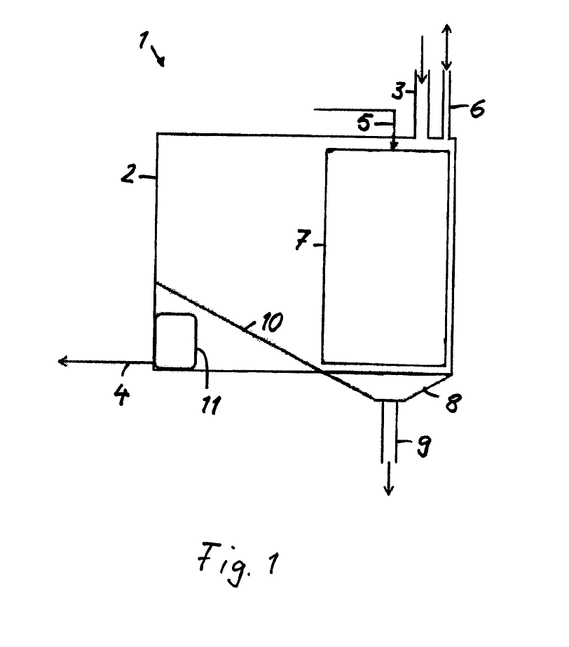

FIG. 1 shows a fuel supply system 1 which can be used in vehicles with internal combustion engine and via which fuel is supplied to the internal combustion engine. The fuel can be either Diesel fuel or gasoline. The fuel supply system 1 comprises a fuel tank 2 featuring a first fuel inlet 3 in the upper part for fueling, and a fuel outlet 4 in the lower part for discharging the fuel towards the internal combustion engine. Adjacent to the first fuel inlet 3 is disposed a second fuel inlet 5 in the upper part of the fuel tank via which a fuel return flow is directed from a fuel filter or the high-pressure side of a fuel supply pump into the tank 2.

In the upper part of the fuel tank 2 can also be located a tank ventilation nozzle 6.

Directly underneath the two fuel inlets 3, 5 is a water separator 7 integrated into the fuel tank 2. The water separator 7 is designed as coalescer element which has, as a consequence of the through-flowing fuel, only a minimal or no pressure loss; accordingly, the water separator 7 is an open fabric.

To the water separator 7 is allocated a water reservoir 8, which is placed directly underneath the water separator 7 and which has a funnel-shaped design extending downwards in the fuel tank 2. The water separated in the water separator 7, which is discharged either continuously or discontinuously via a water outlet 9 in the water reservoir 8, is collected in the water reservoir 8.

The fuel inlets 3, 5 and the fuel outlet 4 are placed at diametrically opposing positions of the fuel tank 2. As the water separator 7 is disposed directly below the fuel inlets 3, 5, the water separator 7 is positioned on the side facing away from the fuel outlet 4 within the fuel tank 2. The fuel supplied to the fuel tank flows through the water separator 7 which is disposed in the flow path between the fuel inlets 3, 5 and the fuel outlet 4.

Furthermore, a hydrophobic barrier layer 10 is integrated into the fuel tank 2. The hydrophobic barrier layer 10 is a separate component, realized separately from the water separator 7 and has a flat or plate-shaped design, respectively. The hydrophobic barrier layer 10 features, for example, a fine-meshed grid made either of a hydrophobic material or coated with a hydrophobic material. The hydrophobic barrier layer 10 extends diagonally in the fuel tank 2, wherein the lowest point of the barrier layer 10 ends in the water reservoir 8 which is allocated to the water separator 7 and disposed directly underneath the water separator. The hydrophobic barrier layer 10 protects the fuel outlet 4 from the water separator 7 so that water droplets, which might be carried away by the water separator 7 and conveyed towards the fuel outlet 4, are separated at the hydrophobic barrier layer 10. Due to the diagonally extending hydrophobic barrier layer 10, the separated water droplets can flow into the water reservoir 8.

Furthermore, a fuel supply pump 11, which is directly disposed at the fuel outlet 4, is integrated into the fuel tank 2. The fuel supply pump 11, too, is protected from the water separator 7 by the hydrophobic barrier layer 10. It thus prevents water droplets from reaching the fuel supply pump 11 and being divided there into smaller droplets due to shear forces.

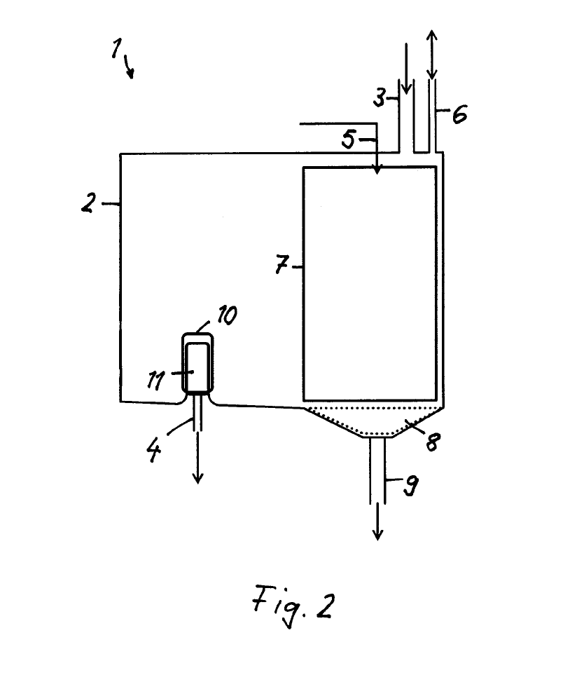

In FIG. 2 is shown a fuel supply system 1 in one variant of an embodiment. As is the case in the first example of an embodiment, the water separator 7 is disposed in the fuel tank 2 directly underneath the fuel inlets 3, 5, wherein separated water can be collected in a water reservoir 8 positioned below and discharged via a water outlet 9. Unlike the first example of an embodiment, the hydrophobic barrier layer 10, however, does not have a flat or plate-shaped design, respectively, but a cylindrical design and overlaps the fuel supply pump 11, which is disposed at a certain distance from the water separator 7. An elevation, which is overlapped by the cylindrically designed hydrophobic barrier layer 10 and prevents separated water from flowing out by accident via the fuel outlet, is realized in the bottom of the fuel tank 2 in the area of the fuel outlet 4. The fuel supply pump 11 can be integrated into the fuel tank 2 or, according to an alternative embodiment, disposed outside of the fuel tank.

The bottom of the fuel tank 2 is inclined in the immediate vicinity of the fuel outlet 4 towards the water reservoir 8 and the water outlet 9. The inclined bottom ensures that the separated water droplets flow back into the water reservoir 8.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A fuel supply system for a vehicle with internal combustion engine, comprising:
a fuel tank;
and a water separator integrated into the fuel tank;
wherein the water separator is disposed in a flow path of the fuel between a fuel inlet and a fuel outlet of the fuel tank.

2. The fuel supply system according to claim 1, further comprising:
a hydrophobic barrier layer disposed between the water separator and the fuel outlet.

3. The fuel supply system according to claim 2, wherein
the hydrophobic barrier layer includes a fine-meshed grid.

4. The fuel supply system according to claim 2, wherein
the hydrophobic barrier layer extends diagonally within the fuel tank;
wherein the deepest point of the hydrophobic barrier layer faces a water reservoir.

5. The fuel supply system according to claim 2, wherein
the hydrophobic barrier layer in the fuel tank is a hydrophobic barrier layer;
wherein the hydrophobic barrier layer overlaps the fuel outlet of the fuel tank.

6. The fuel supply system according to claim 1, wherein
the water separator comprises a coalescer element.

7. The fuel supply system according to claim 1, further comprising:
a water reservoir disposed underneath the water separator.

8. The fuel supply system according to claim 5, wherein
the hydrophobic barrier layer ends in the water reservoir disposed underneath the water separator.

9. The fuel supply system according to claim 1, wherein
the fuel inlet is arranged in the upper side of the fuel tank; and
the water separator is disposed underneath the fuel inlet.

10. The fuel supply system according to claim 1, wherein
a first fuel inlet and a second fuel inlet are realized in the fuel tank; and
the water separator is disposed at a specified desired distance from both fuel inlets.

11. The fuel supply system according to claim 1, wherein
the water separator is disposed on the side in the fuel tank opposing the fuel outlet.

12. The fuel supply system according to claim 1, wherein
a fuel supply pump is provided downstream of the water separator.

13. The fuel supply system according to claim 12, wherein
the fuel supply pump is integrated into the fuel tank.

14. The fuel supply system according to claim 1, wherein
the fuel tank has a bottom that is inclined towards the water reservoir.

15. The fuel supply system according to claim 1, wherein
the bottom of the fuel tank forms an elevation in the area of the fuel outlet.
